(19) United States
(12) Patent Application Publication
(10) Pub. No.: US 2024/0361275 A1
(43) Pub. Date: Oct. 31, 2024

(54) LABORATORY SCALE DEPOSITION MEASUREMENT WITH FLUSH MOUNTED CRYSTAL AND FREE-FLOATING LIQUID-FACING CRYSTAL SURFACE OF A QUARTZ CRYSTAL MICROBALANCE ASSEMBLY

(71) Applicant: ChampionX LLC

(72) Inventor: Yuntao Thomas Hu, Conroe, TX (US)

(21) Appl. No.: 18/643,390

(22) Filed: Apr. 23, 2024

Related U.S. Application Data
(60) Provisional application No. 63/498,169, filed on Apr. 25, 2023.

(51) Int. Cl. G01N 29/02

(52) U.S. Cl. CPC G01N 29/022; G01N 2291/022; G01N 2291/0426

(57) ABSTRACT

A liquid-facing crystal surface of a crystal of a quartz crystal microbalance assembly is flush mounted with respect to an inner surface of a wall of a laboratory-scale equipment for purposes of measuring particle deposition from a liquid under high shear conditions. The side(s) of the crystal does not bond with a side wall of a hole formed in the wall of the equipment or with a side wall of a housing or support member, so as to allow un-impeded shear oscillation of a liquid-facing crystal surface relative to a dry-facing crystal surface of the crystal in a thickness shear mode of operation.

### CROSS-REFERENCE TO RELATED APPLICATION

This application is a non-provisional patent application claiming the benefit of, and priority to, U.S. Provisional Patent Application No. 63/498,169, filed Apr. 25, 2023, which is incorporated by reference herein in its entirety.

### FIELD OF THE DISCLOSURE

The present disclosure generally relates to quartz crystal microbalance assemblies, and more particularly to quartz crystal microbalance assemblies used to measure particle deposition.

### BACKGROUND

Quartz crystal microbalance technology provides a very sensitive way to measure particle deposition on a surface of the crystal of a quartz crystal microbalance assembly. Quartz crystals exhibit a piezoelectric effect when alternating current or voltage is applied to the crystal via one or more electrodes. Quartz crystal microbalance assemblies can be configured to operate in various modes, such as a thickness-shear mode or a flexural mode. The crystal oscillations generate a resonant frequency (e.g., a standing shear wave for thickness shear mode) for the crystal. A mass measurement determined from the resonant frequency depends upon the resonant frequency generated by oscillation of the quartz crystal. Thus, when particles are deposited upon the surface of the crystal, the resonant frequency correspondingly changes. The difference between a resonant frequency measured at a first point in time and another resonant frequency measured at a second point in time corresponds to the mass of the particles deposited on the crystal surface during the interval of time. Various techniques exist for calculation the amount of particles (e.g., via mass value) based on the resonant frequencies of the crystal measured over time.

Asphaltenes are highly prevalent in crude oils, thus requiring special attention during the extraction and processing of these crude oils. Asphaltenes can deposit on surfaces, e.g., blocking reservoir pores in near-well formations, depositing a layer of particles on production equipment (e.g., tubing, pumps), and depositing a layer of particles on equipment downstream of the production equipment (e.g., desalters, pipelines, etc.). Chemical treatment of crude oil with additives, such as dispersants and inhibitors, is one of the most commonly adopted control options for the remediation and prevention of asphaltene deposition.

In order to determine the effectiveness of an inhibitor for inhibiting asphaltene deposition on equipment in the field, laboratory tests may be performed. For example, a quartz crystal microbalance assembly may be used to measure the asphaltene deposition that is incurred after treatment with a variety of doses of the inhibitor in a laboratory setup. Based upon this laboratory testing, a prediction may be made for a suitable dose of inhibitor that will be expected to inhibit asphaltene deposition in the field.

There is ongoing need to correlate particle deposition measured on a laboratory scale with the deposition in the field.

### SUMMARY

In some aspects, the techniques described herein relate to a process for measuring a particle deposition value in a laboratory-scale equipment, the process including: flowing a liquid in or through the laboratory-scale equipment; during flowing, contacting the liquid with a liquid-facing crystal surface of a crystal of a quartz crystal microbalance assembly; detecting a resonant frequency of the crystal of the quartz crystal microbalance assembly based on the contacting; and converting the resonant frequency to the particle deposition value, wherein the liquid-facing crystal surface of the crystal is flush with an inner surface of a wall of the laboratory-scale equipment, wherein the liquid-facing crystal surface is free-floating for shear oscillation of the liquid-facing crystal surface in a first plane relative to a dry-facing crystal surface of the crystal in a second plane, wherein the first plane is parallel to the second plane.

In some aspects, the techniques described herein relate to a laboratory-scale equipment configured to measure particle deposition of a liquid, including: a wall including a hole formed therein; and a quartz crystal microbalance assembly including a crystal, wherein the crystal extends into the hole of the wall, wherein a liquid-facing crystal surface of the crystal is flush with an inner surface of the wall of the laboratory-scale equipment, wherein the liquid-facing crystal surface is free-floating for shear oscillation of the liquid-facing crystal surface in a first plane relative to a dry-facing crystal surface of the crystal in a second plane, wherein the first plane is parallel to the second plane.

In some aspects, the techniques described herein relate to a process for mounting a crystal of a quartz crystal microbalance assembly to a wall of a laboratory-scale equipment, including: placing the crystal into a hole formed in the wall of the laboratory-scale equipment such that a liquid-facing crystal surface of the crystal is flush with an inner surface of the wall of the laboratory-scale equipment, wherein the hole includes a first portion and a second portion that are configured to form an abutment surface; and connecting an edge of a dry-facing crystal surface of the crystal to the abutment surface, wherein a side of the crystal i) faces a side wall of the first portion of the hole, ii) is not bonded to the side wall of the first portion of the hole, or iii) faces a side wall of the first portion of the hole and is not bonded to the side wall of the first portion of the hole.

In some aspects, the techniques described herein relate to a process for mounting a crystal of a quartz crystal microbalance assembly to a wall of a laboratory-scale equipment, including: placing the crystal into a hole in the wall of the laboratory-scale equipment such that a liquid-facing crystal surface of the crystal is flush with an inner surface of the wall of the laboratory-scale equipment, wherein the quartz crystal microbalance assembly includes a support member having a first portion extending into the hole and a second portion extending on an outer surface of the wall of the laboratory-scale equipment, wherein an edge of a dry-facing crystal surface of the crystal is bonded to an abutment surface of the first portion of the support member; and connecting the second portion of the support member to the outer surface of the wall, wherein a side of the crystal i) faces a side wall of the hole, ii) is not bonded to the side wall of the hole, or iii) faces a side wall of the hole and is not bonded to the side wall of the hole.

In some aspects, the techniques described herein relate to a process for mounting a crystal of a quartz crystal microbalance assembly to a wall of a laboratory-scale equipment, including: placing the quartz crystal microbalance assembly into a hole in the wall of the laboratory-scale equipment such that a liquid-facing crystal surface of the crystal is flush with an inner surface of the wall of the laboratory-scale equipment, wherein the quartz crystal microbalance assembly includes a housing, a support member, and the crystal, wherein the support member has a first portion and a second portion, wherein the second portion extends along an abutment surface of the housing, wherein an edge of a dry-facing crystal surface of the crystal is bonded to an abutment surface of the first portion of the support member, wherein the second portion of the support member is connected to the inner surface of the housing; and connecting the housing to the wall of the laboratory-scale equipment, wherein a side of the crystal i) faces an inside surface of the support member, ii) is not bonded to the inside surface of the support member, or iii) faces an inside surface of the support member and is not bonded to the inside surface of the support member

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 is a cross-sectional side view of a conventional quartz crystal microbalance (QCM) assembly mounted to a wall of a laboratory-scale equipment in a recessed configuration.

FIG. 2 is a perspective view of a particle deposition measurement system using a QCM assembly mounted to a laboratory-scale equipment as disclosed herein.

FIG. 3A is partial cross-sectional plan view taken along sight line 2-2 of FIG. 2, that includes the wall of the equipment, with the QCM assembly removed for clarity.

FIG. 3B is a partial cross-sectional plan view taken along sight line 2-2 of FIG. 2, with the crystal, pin holder, and contact pins of an embodiment of the QCM assembly.

FIG. 4A is partial cross-sectional plan view taken along sight line 2-2 of FIG. 2, that includes the wall of the equipment, with the QCM assembly removed for clarity.

FIG. 4B is a partial cross-sectional plan view taken along sight line 2-2 of FIG. 2, with the crystal, support member, pin holder, and contact pins of another embodiment of the QCM assembly.

FIG. 5A is partial cross-sectional plan view taken along sight line 2-2 of FIG. 2, that includes the wall of the equipment, with the QCM assembly removed for clarity.

FIG. 5B is a partial cross-sectional plan view taken along sight line 2-2 of FIG. 2, with the housing, crystal, support member, pin holder, and contact pins of another embodiment of the QCM assembly.

### DETAILED DESCRIPTION

Disclosed herein are a process for measuring a particle deposition value in a liquid flow of a laboratory-scale equipment, a laboratory-scale equipment configured to measure particle deposition of a liquid containing particles, and several processes for mounting a crystal of a quartz crystal microbalance assembly to a wall of a laboratory-scale equipment. These processes and equipment can be used for any liquid containing particles that deposit on surfaces of equipment through which the liquid moves or is transported. Exemplary processes and equipment may be described herein with respect to asphaltene deposition from a hydrocarbon liquid; however, it is contemplated that the processes and equipment can be used to measure deposition of other particles from hydrocarbon liquids or other liquids.

The term “crystal” as used herein refers to a wafer of quartz crystal with electrodes connected to the wafer. The crystal can also be referred to as a resonator crystal, a piezoelectric resonator, or a quartz crystal microbalance sensor. The crystal disclosed herein is cut and configured in a manner to operate in a thickness shear mode. For example, the crystal can have a largest dimension (e.g., a diameter, a length, or a width) in a range of from 12.7 mm to 25.4 mm and a smallest dimension (e.g., a thickness) in a range of from 0.01 mm to 1 mm.

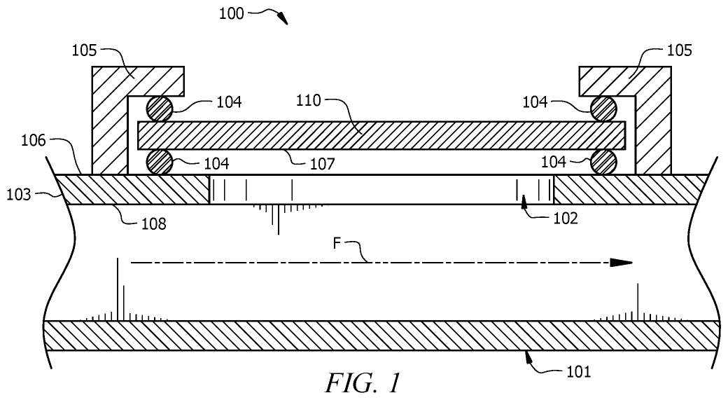

FIG. 1 is a cross-sectional side view of a conventional quartz crystal microbalance (QCM) assembly 100 mounted to a wall of a laboratory-scale equipment 101 in a recessed configuration. As shown in FIG. 1, for laboratory-scale measurements, a crystal 110 of a QCM assembly 100 is mounted to a laboratory-scale equipment 101 via a hole 102 formed in the wall 103 of the equipment 101. The electrode and other parts of the QCM assembly 100 are not illustrated in FIG. 1 for clarity. The crystal 110 of the QCM assembly 100 is mounted between two O-rings 104 (or other resilient members), which are held in place by supports 105 that are attached to an outside surface 106 of a wall 103 of the equipment 101. Such a configuration makes the fluid-side surface 107 of the crystal 110 recessed with respect to an inner surface 108 of the wall 103 of the equipment 101.

When the mounting configuration of the crystal 110 of the QCM assembly 100 in FIG. 1 is used to measure asphaltene deposition in a flow of liquid through the equipment 101, the intensities of the flow in the vicinity of fluid-side surface 107, including the magnitude of the shear stress and thickness of the turbulence boundary layer, are dramatically reduced compared to that near the vessel inner surface. Because of this, it is extremely difficult to replicate the flow conditions in the field production pipe with such a configuration in the lab, which is believed to be critical to correlate the deposition rate measured in the lab with that in the field.

Better correlation between laboratory-scale measurement of and field deposition of a hydrocarbon liquid can be achieved by mounting a quartz crystal microbalance (QCM) assembly such that the liquid-facing crystal surface of the crystal of the QCM assembly (i.e., the surface that is contact with, and faces, the liquid flowing past the crystal surface, also called the fluid-side surface) is flush with the inner surface of the laboratory-scale equipment in which the QCM assembly is mounted. In this manner, the flow conditions in the field can be better mimicked in the lab. Moreover, when flush-mounted, the sides of the crystal of the QCM assembly are not bonded to any equipment or adhesive, and the liquid-facing crystal surface of the crystal is free-floating in the configurations disclosed herein.

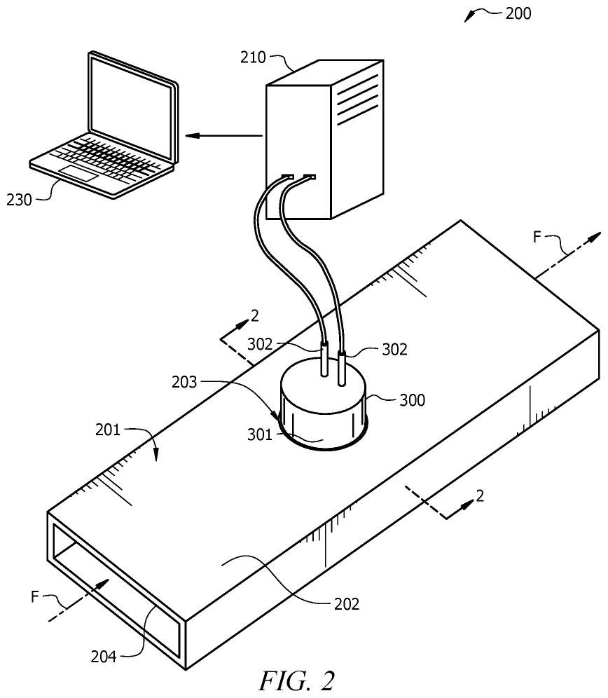

FIG. 2 is a perspective view of a particle deposition measurement system 200 using a QCM assembly 300 mounted to a wall 202 of a laboratory-scale equipment 201 according to a configuration disclosed herein. When in use for measuring particle deposition of a liquid and as illustrated in FIG. 2, liquid flows in the equipment 201, e.g., in a direction of arrows F. While a slot flow channel is illustrated as the equipment 201 in FIG. 2, the equipment 201 can be embodied as any other laboratory-scale equipment used for measuring asphaltene deposition (e.g., a Couette apparatus, a pipe).

A hole 203 is formed in the wall 202 of the equipment 201, and the QCM assembly 300 is placed in the hole 203 such that the crystal of the QCM assembly 300 is flush with the inner surface 204 of the wall 202. The crystal of the QCM assembly 300 can be mounted according to a technique and configuration disclosed herein so that the liquid-facing crystal surface (the side of the crystal that faces the liquid) of the quartz crystal of the QCM assembly 300 is flush with the inner surface 204 of the wall 202 (e.g., the surface of the wall 202 that faces the interior of the equipment 201). In aspects, “flush” means that the liquid-facing crystal surface of the crystal of the QCM assembly 300 and the inner surface 204 of the wall 202 of the laboratory-scale equipment 201 are disposed in a same plane.

In FIG. 2, it can be seen that the QCM assembly 300 can include a housing or pin holder 301 and two spring-loaded contact pins 302 extending outside of the housing or pin holder 301. Each of the spring-loaded contact pins 302 extends inside the housing or pin holder 301 and is in electrical contact with the electrode(s) associated with the quartz crystal of the QCM assembly 300.

The particle deposition measurement system 200 can additionally include an oscillator/frequency analyzer 210 (e.g., an Agilent Universal Frequency Counter or Universal Frequency Counter/Timer) in electrical signal communication with a computer 230. The oscillator/frequency analyzer 210 and computer 230 are configured and adapted to receive an electrical signal from the QCM assembly 300 that is representative of the oscillation frequency of the quartz crystal and to calculate a mass or mass flow rate of the asphaltene particles deposited on the liquid-facing crystal surface of the quartz crystal of the QCM assembly 300.

The manner in which the QCM assembly 300 is arranged and mounted within the hole 203 is described in more detail herein.

In operation of the particle deposition measurement system 200, a liquid can flow in the laboratory-scale equipment 201. During flow of the liquid through the equipment 201, the liquid can contact a liquid-facing crystal surface of the crystal of the QCM assembly 300. Contact of the liquid with the liquid-facing crystal surface can result in deposition of particles (e.g., asphaltenes from a hydrocarbon liquid) on the liquid-facing crystal surface. The oscillator/frequency analyzer 210 detects the resonant frequency of the crystal of the QCM assembly 300, and the oscillator/frequency analyzer 210 and/or the computer 230 can convert the resonant frequency to a particle deposition value.

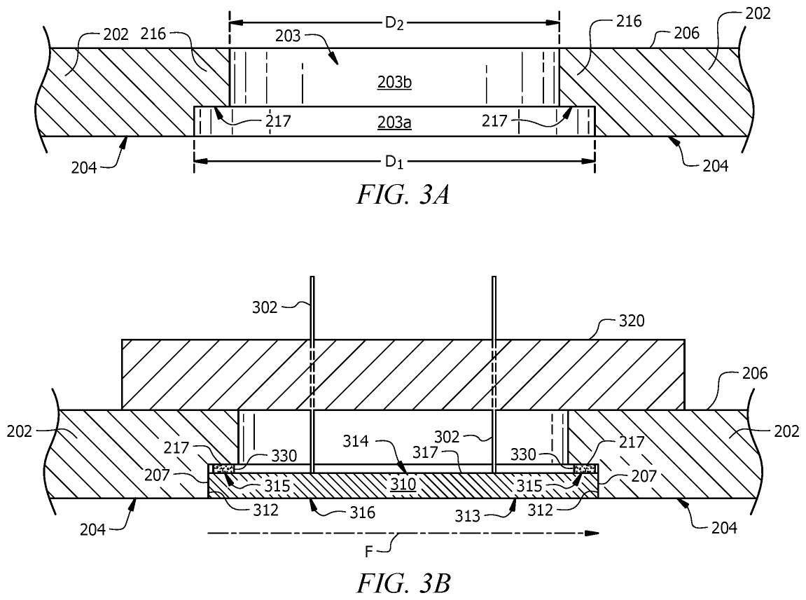

FIG. 3A is a partial cross-sectional plan view taken along sight line 2-2 of FIG. 2, that includes the wall 202 of the equipment 201, with the QCM assembly 300 removed for clarity. The hole 203 can be seen formed in the wall 202. The hole 203 is a stepped hole, and has a first portion 203a and a second portion 203b. The first portion 203a of the hole 203 is disposed adjacent the inner surface 204 of the wall 202 and adjacent to the flow F of the liquid. The first portion 203a and has a diameter D₁. The second portion 203b of the hole 203 is disposed adjacent an outer surface 206 of the wall 202 and is concentric with the first portion 203a. The second portion 203b has a diameter D₂, where diameter D₂ is less than diameter D₁. In aspects, the hole 203 is generally circular in shape; however, it is contemplated that the hole 203 (and portions 203a and 203b) can have any shape that matches the shape of the components of a QCM assembly that extend into the hole 203.

The difference between diameter D₁ of first portion 203a and diameter D₂ of second portion 203b forms a shoulder 216 in the wall 202. The shoulder 216 has an abutment surface 217 to which the quartz crystal 310 of the QCM assembly 300 is bonded (see FIG. 3B). In aspects, a plane of the abutment surface 217 is parallel to a plane of the inner surface 204 of the wall 202. In aspects, the plane of the abutment surface 217 is parallel to a plane of the liquid-facing crystal surface of the crystal of the QCM assembly 300.

FIG. 3B is a partial cross-sectional plan view taken along sight line 2-2 of FIG. 2, with the crystal 310, pin holder 320, and contact pins 302 of an embodiment of the QCM assembly 300.

In aspects, the crystal 310 can have a disc shape. The disc shape can be circular disc, rectangular disc, or any other shape. In aspects, the quartz crystal 310 has a metal or alloy coating functioning as electrodes.

The quartz crystal 310 is disposed in the first portion 203a of the hole 203. In aspects, the diameter D₁ is equal to or greater than a diameter of the quartz crystal 310. The quartz crystal 310 has a wet side 313 (or liquid side) that faces the liquid flowing in the equipment 201 and a dry side 314 that faces the second portion 203b of the hole 203 and the pin holder 320. Edges 315 of the dry-facing crystal surface 317 of the quartz crystal 310 are bonded to the abutment surface 217 of the shoulder 216 formed by the first portion 203a and second portion 203b of the hole 203 in the wall 202. In aspects, the edges 315 are bonded to the abutment surface 217 with an adhesive material 330 such as an epoxy adhesive. In aspects, the wet side 313 of the quartz crystal 310 is flush with an inner surface 204 of the wall 202.

Two spring-loaded contact pins 302 extend through apertures formed in the pin holder 320. Ends of the contact pins 302 contact the electrode(s) of the quartz crystal 310 and opposite ends of the spring-loaded contact pins 302 extend out of the pin holder 320, where the spring-loaded contact pins 302 may be electrically connected with the oscillator/frequency analyzer 210 (e.g., via wires). The pin holder 320 is secured to the wall 202 with a fastener (such as a threaded bolt), or any other technique known in the art with the aid of this disclosure. The two apertures formed in the pin holder 320 serve to stabilize the spring-loaded contact pins 302 and hold the spring-loaded contact pins 302 in place.

The quartz crystal 310 experiences shear oscillation (e.g., a movement of the liquid-facing crystal surface 316 in a first plane relative to a dry-facing crystal surface 317 in a second plane, where the first plane is parallel to the second plane) when operating in thickness-shear mode within the first portion 203a of the hole 203.

By connecting the edges 315 of the dry-facing crystal surface 317 to the abutment surface 217, the dry-facing crystal surface 317 is generally fixed in place, while the liquid-facing crystal surface 316 is not fixed. Thus, the liquid-facing crystal surface 316 is free-floating for purposes of shear oscillation of the liquid-facing crystal surface 316 in a first plane relative to the dry-facing crystal surface 317 in a second plane, where the first plane is parallel to the second plane.

If the side 312 of the crystal 310 were to be bonded to the side wall 207, shear oscillation of the liquid-facing crystal surface 316 of the quartz crystal 310 would be impeded. Without being limited by theory, it is believed that having no bond between the side 312 and side wall 207 provides a more accurate resonant frequency of the shear oscillation of the quartz crystal 310 and more accurately represents the actual amount of particle (e.g., asphaltene) deposition on the liquid-facing crystal surface 316 of the quartz crystal 310.

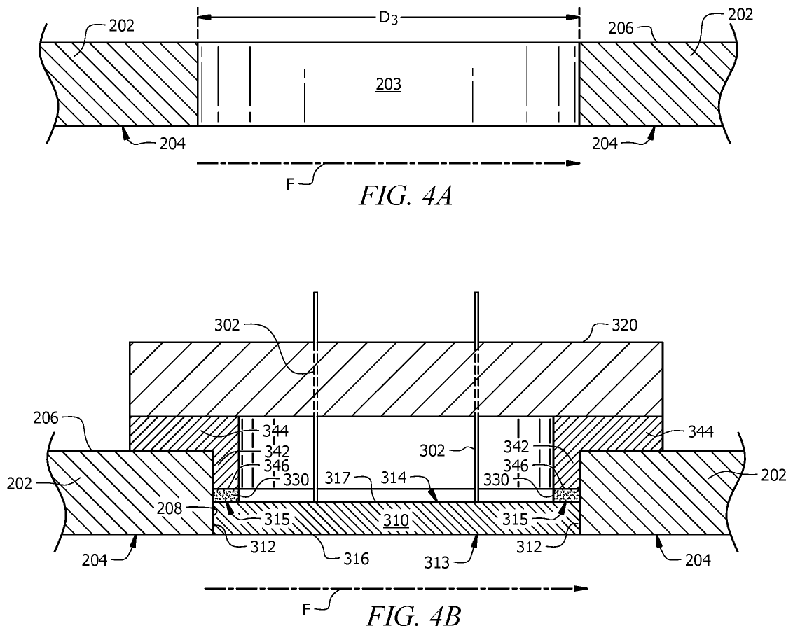

FIG. 4A is partial cross-sectional plan view taken along sight line 2-2 of FIG. 2, that includes the wall 202 of the equipment 201, with the QCM assembly 300 removed for clarity. In FIG. 4A, it can be seen that the hole 203 in the wall 202 has a uniform diameter D₃. In other aspects, the diameter D₃ of the hole 203 in the wall 202 does not have to be uniform.

FIG. 4B is a partial cross-sectional plan view taken along sight line 2-2 of FIG. 2, with the crystal 310, pin holder 320, contact pins 302, and support member 340 of another embodiment of the QCM assembly 300.

The crystal 310 is the same as described for FIG. 3B, except for the connection of edges 315 to the support member 340 as described in more detail below. In aspects, the diameter D₃ of the hole 203 is equal to or greater than a diameter of the quartz crystal 310.

The support member 340 of the QCM assembly 300 has a first portion 342 and a second portion 344. In aspects, the support member 340 is configured as a ridged annular ring. The first portion 342 and the second portion 344 can be integrally formed, for example; or alternatively, the first portion 342 and the second portion 344 can be two separate pieces connected to one another. The first portion 342 of the support member 340 extends within the hole 203 and has an abutment surface 346 that is bonded to the edges 315 of the quartz crystal 310, e.g., via adhesive material 330 as described above. The second portion 344 of the support member 340 extends outside the hole 203 and extends at least partially along the outer surface 206 of the wall 202 of the equipment 201. The second portion 344 can be connected to outer surface 206 of the wall 202 via a fastener or any other technique known in the art with the aid of this disclosure.

The pin holder 320 is connected to the second portion 344 of the support member 340, via any technique known in the art with the aid of this disclosure, such as by a fastener, or any other technique known in the fastening art. In aspects, a fastener such as a screw can secure the pin holder 320 to the support member 340 and to the wall 202. The pin holder and the support member can be a single body.

The pin holder 320 and spring-loaded contact pins 302 are configured as described in the description of FIG. 3B, except that the pin holder 320 is connected to the support member 340 and not to the outer surface 206 of the wall 202 of the equipment 201.

The quartz crystal 310 experiences shear oscillation (e.g., a movement of the liquid-facing crystal surface 316 in a first plane relative to a dry-facing crystal surface 317 in a second plane, where the first plane is parallel to the second plane) when operating in thickness-shear mode within the hole 203.

By connecting the edges 315 of the dry-facing crystal surface 317 to the abutment surface 346, the dry-facing crystal surface 317 is generally fixed in place, while the liquid-facing crystal surface 316 is not fixed. Thus, the liquid-facing crystal surface 316 is free-floating for purposes of shear oscillation of the liquid-facing crystal surface 316 in a first plane relative to the dry-facing crystal surface 317 in a second plane, where the first plane is parallel to the second plane.

If the side 312 of the crystal 310 were to be bonded to the side wall 208, shear oscillation of the liquid-facing crystal surface 316 of the quartz crystal 310 would be impeded. Without being limited by theory, having no bond between the side 312 and side wall 208 provides more accurate resonant frequency of the shear oscillation of the quartz crystal 310 and more accurately represents the actual amount of particle (e.g., asphaltene) deposition on the liquid-facing crystal surface 316 of the quartz crystal 310.

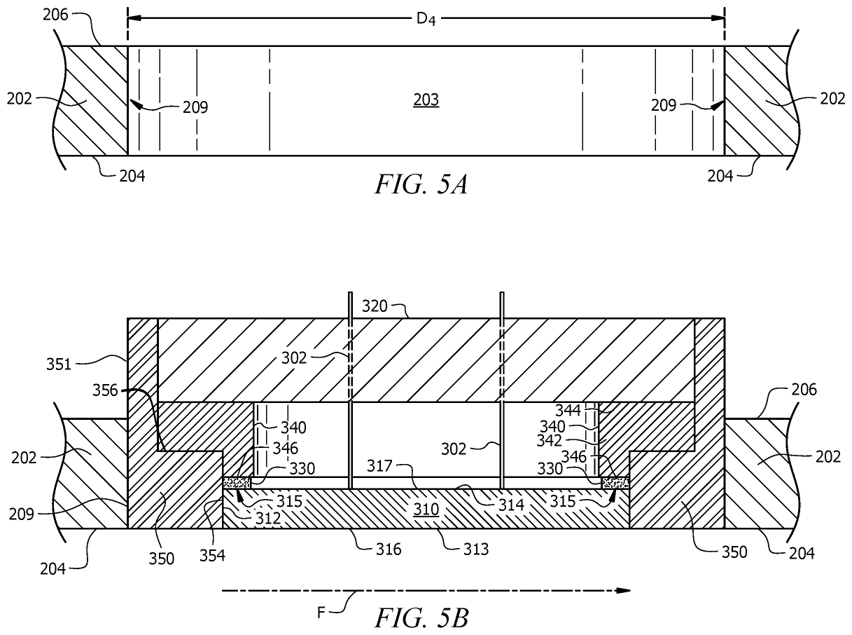

FIG. 5A is partial cross-sectional plan view taken along sight line 2-2 of FIG. 2, that includes the wall 202 of the equipment 201, with the QCM assembly 300 removed for clarity. It can be seen that the hole 203 has a uniform diameter D₄. In other aspects, the diameter D₃ of the hole 203 in the wall 202 does not have to be uniform. The side wall 209 of the hole 203 can be configured to face an outer surface 351 of the housing 350 described in FIG. 5B. In some aspects, the side wall 209 of the hole 203 can be secured to the outer surface 351 of the housing 350 (e.g., with adhesive or threads); alternatively, another part of the housing 350 can be secured to the equipment 201.

FIG. 5B is a partial cross-sectional plan view taken along sight line 2-2 of FIG. 2, with the crystal 310, pin holder 320, contact pins 302, support member 340, and housing 350 of another embodiment of the QCM assembly 300. The support member 340 and housing 350 have portions that are flush with the inner surface 204 of the wall 202 of the laboratory-scale equipment 201.

The crystal 310 is the same as described for FIG. 4B, with the edges 315 bonded to the support member 340. Different than the crystal 310 in FIG. 4B, the crystal 310 in FIG. 5B is contained within the housing 350, and the crystal 310 has side 312 that faces the inside surface 354 of the housing 350. In aspects, the inside surface 354 is not bonded to the side 312 of the crystal 310. In aspects, the diameter of the inside surface 354 of the housing 350 is equal to or greater than a diameter of the quartz crystal 310.

The support member 340 is contained within the housing 350. The support member 340 of the QCM assembly 300 has a first portion 342 and a second portion 344. In aspects, the support member 340 is configured as a ridged annular piece. The first portion 342 and the second portion 344 can be integrally formed, for example; or alternatively, the first portion 342 and the second portion 344 can be separate pieces that are connected to one another. The first portion 342 of the support member 340 extends within the housing 350 and has an abutment surface 346 that is bonded to the edges 315 of the quartz crystal 310, e.g., via adhesive material 330 as described above. The second portion 344 of the support member 340 extends at least partially along an abutment surface 356 of housing 350.

The pin holder 320 and spring-loaded contact pins 302 are configured as described in the description of FIG. 3B, except that the pin holder 320 is connected to the support member 340 and not to the outer surface 206 of the wall 202 of the equipment 201 and the pin holder 320 is contained within the housing 350. The pin holder and the support member can be a single body.

The housing 350 contains the crystal 310, support member 340, and the pin holder 320 of the QCM assembly 300. The housing 350 can be connected to the side wall 209 of the hole 203 formed in the wall 202 of the equipment 201 or to another part of the laboratory equipment 201, for example, via threads and/or adhesive. The outer surface 351 of the housing 350 can extend into the hole 203 formed in the wall 202.

The housing 350 can have an abutment surface 356 formed therein. The second portion 344 of the support member 340 contacts and optionally connects (e.g., via adhesive or fastener) to the abutment surface 356 of the housing 350. The first portion 342 of the support member 340 extends within the housing 350 and has an abutment surface 346 that is bonded to the edges 315 of the quartz crystal 310, e.g., via adhesive as described above.

The housing 350 is formed of a rigid material, such as a hard plastic or metal. In aspects, the portion of the housing 350 that faces the side 312 of the crystal 310 is not formed of a resilient material.

The quartz crystal 310 experiences shear oscillation (e.g., a movement of the liquid-facing crystal surface 316 in a first plane relative to a dry-facing crystal surface 317 in a second plane, where the first plane is parallel to the second plane) when operating in thickness-shear mode within the housing 350.

By connecting the edges 315 of the dry-facing crystal surface 317 to the abutment surface 346 of the support member 340, the dry-facing crystal surface 317 is generally fixed in place, while the liquid-facing crystal surface 316 is not fixed. Thus, the liquid-facing crystal surface 316 is free-floating for purposes of shear oscillation of the liquid-facing crystal surface 316 in a first plane relative to the dry-facing crystal surface 317 in a second plane, where the first plane is parallel to the second plane.

If the side 312 were bonded to the inside surface 354 of the housing 350, shear oscillation of the liquid-facing crystal surface 316 of the quartz crystal 310 would be impeded since the edges 315 of the dry-facing crystal surface 317 are bonded to inside surface 354. Without being limited by theory, it is believed that having no bond between the side 312 of the crystal 310 and the inside surface 354 of the housing 350 provides more accurate resonant frequency of the quartz crystal 310 and more accurately represents the actual amount of particle (e.g., asphaltene) deposition on the liquid-facing crystal surface 316 of the quartz crystal 310.

Within the scope of this disclosure, it is contemplated that, in FIG. 3B, FIG. 4B, and FIG. 5B, a gap can be present between the inside surface of the hole or housing that holds the QCM assembly 300 and the side 312 of the crystal 310. For example, in FIG. 3B, a gap can be present between the side wall 207 of the hole 203 and the side 312 of the crystal 310. In FIG. 4B, a gap can be present between the side wall 208 of the hole 203 and the side 312 of the crystal 310. In FIG. 5B, a gap can be present between the inside surface 354 of the housing 350 and the side 312 of the quartz crystal 310. The gap can be of any size.

During use of the laboratory-scale equipment 201 to measure a particle deposition value (e.g., asphaltene deposition value), a flow of the liquid (e.g., a hydrocarbon liquid) through or within the equipment 201 is initiated. During flowing, the liquid-facing crystal surface 316 of the crystal 310 is contacted with the flow of liquid. A resonant frequency of the crystal 310 based upon such contact is detected (i.e., measured) that is based upon the contact. The oscillator/frequency analyzer 210 and computer 230 convert the resonant frequency to a particle deposition value according to a technique known in the art with the aid of this disclosure.

In aspects, flow of the liquid creates a shear stress on the liquid-facing crystal surface 316 of the crystal 310 of greater than or equal to 0.01 Pa e.g., in a range of from 0.01 to 1,000 Pa. In aspects, the crystal 310 is exposed to a shear under laboratory equipment conditions that is comparable to the shear of a liquid in field equipment. For example, the crystal 310 can be exposed to a shear under laboratory equipment conditions that is comparable to the shear of a hydrocarbon liquid in oil and gas field equipment. In contrast, laboratory measurements with the recessed crystal are usually conducted under a shear of less than 0.01 Pa. Without being limited by theory, flush-mounting the crystal 310 as disclosed herein, using a liquid shear of a value herein, or combinations thereof, provides more accurate particle (e.g., asphaltene) deposition values under laboratory testing, and more accurately represents particle (e.g., asphaltene) deposition conditions experienced in the field. In aspects, the crystal 310 can be exposed to a shear in a range of from 0.05 to 500 Pa; alternatively, from 0.1 to 200 Pa; alternatively, from 1 to 100 Pa.

The only mounting connection on the crystal 310 of the embodiments disclosed herein is the edge(s) 315 of the dry-facing crystal surface 317. It was unexpectedly found that, when edges 315 of the dry-facing crystal surface 317 of the crystal 310 are bonded to a rigid surface (such as an abutment surface 217 the wall 202 of the equipment 201 or an abutment surface 346 of a support member 340), the shear oscillation of the crystal 310 can still be activated and used for particle deposition measurement because the liquid-facing crystal surface 316 experiences shear oscillation relative to the dry-facing crystal surface 317 of the crystal 310. Shear oscillation of the liquid-facing crystal surface 316 is not impeded since the side 312 of the crystal 310 not being bonded to anything as discussed in the embodiments herein.

### Additional Description

Aspect 1. A process for measuring a particle deposition value in a laboratory-scale equipment, the process comprising: flowing a liquid in or through the laboratory-scale equipment; during flowing, contacting the liquid with a liquid-facing crystal surface of a crystal of a quartz crystal microbalance assembly; detecting a resonant frequency of the crystal of the quartz crystal microbalance assembly based on the contacting; and converting the resonant frequency to the particle deposition value, wherein the liquid-facing crystal surface of the crystal is flush with an inner surface of a wall of the laboratory-scale equipment, wherein the liquid-facing crystal surface is free-floating for shear oscillation of the liquid-facing crystal surface in a first plane relative to a dry-facing crystal surface of the crystal in a second plane, wherein the first plane is parallel to the second plane.

Aspect 2. The process of aspect 1, wherein the first plane of the liquid-facing crystal surface of the crystal is parallel to a direction of flow of the liquid.

Aspect 3. The process of aspect 1 or aspect 2, wherein the liquid-facing crystal surface of the crystal is exposed to a shear in a range of from 0.01 to 1,000 Pa during contacting the liquid with the liquid-facing crystal surface of the crystal.

Aspect 4. The process of any one of aspects 1 to 3, wherein the liquid-facing crystal surface of the crystal is exposed to a shear in a range of from 0.1 to 100 Pa during contacting the liquid with the liquid-facing crystal surface of the crystal.

Aspect 5. The process of any one of aspects 1 to 4, wherein the quartz crystal microbalance assembly extends through a hole in the wall of the laboratory-scale equipment.

Aspect 6. The process of aspect 5, wherein the hole comprises a first portion and a second portion configured to form an abutment surface, wherein an edge of the dry-facing crystal surface of the crystal is bonded to the abutment surface.

Aspect 7. The process of aspect 6, wherein a side of the crystal faces a side wall of the first portion of the hole.

Aspect 8. The process of aspect 6 or aspect 7, wherein a side of the crystal is not bonded to a side wall of the first portion of the hole.

Aspect 9. The process of aspect 5, wherein the quartz crystal microbalance assembly comprises a support member having a first portion extending into the hole and a second portion extending on an outer surface of the wall of the laboratory-scale equipment, wherein the second portion of the support member is connected to the outer surface of the wall, wherein an edge of the dry-facing crystal surface of the crystal is bonded to an abutment surface of the first portion of the support member.

Aspect 10. The process of aspect 9, wherein a side of the crystal faces a side wall of the hole.

Aspect 11. The process of aspect 9 or aspect 10, wherein a side of the crystal is not bonded to a side wall of the hole.

Aspect 12. The process of aspect 5, wherein the quartz crystal microbalance assembly comprises a housing, a support member, and the crystal, wherein the support member has a first portion and a second portion, wherein the second portion extends at least partially along an abutment surface of the housing, wherein an edge of the dry-facing crystal surface of the crystal is bonded to an abutment surface of the first portion of the support member, wherein the second portion of the support member is connected to an abutment surface of the housing.

Aspect 13. The process of aspect 12, wherein a side of the crystal faces an inside surface of the support member.

Aspect 14. The process of aspect 12 or aspect 13, wherein a side of the crystal is not bonded to an inside surface of the support member.

Aspect 15. A laboratory-scale equipment configured to measure particle deposition of a liquid, comprising: a wall comprising a hole formed therein; and a quartz crystal microbalance assembly comprising a crystal, wherein the crystal extends into the hole of the wall, wherein a liquid-facing crystal surface of the crystal is flush with an inner surface of the wall of the laboratory-scale equipment, wherein the liquid-facing crystal surface is free-floating for shear oscillation of the liquid-facing crystal surface in a first plane relative to a dry-facing crystal surface of the crystal in a second plane, wherein the first plane is parallel to the second plane.

Aspect 16. The laboratory-scale equipment of aspect 15, wherein the hole comprises a first portion and a second portion configured to form an abutment surface, wherein an edge of the dry-facing crystal surface of the crystal is connected to the abutment surface, wherein a side of the crystal i) faces a side wall of the first portion of the hole and ii) is not bonded to the side wall of the first portion of the hole.

Aspect 17. The laboratory-scale equipment of aspect 15, wherein the quartz crystal microbalance assembly comprises a support member having a first portion extending into the hole and a second portion extending on an outer surface of the wall of the laboratory-scale equipment, wherein an edge of the dry-facing crystal surface of the crystal is bonded to an abutment surface of the first portion of the support member, wherein the second portion of the support member is connected to the wall via the outer surface of the wall, wherein a side of the crystal i) faces a side wall of the hole and ii) is not bonded to the side wall of the hole.

Aspect 18. The laboratory-scale equipment of aspect 15, wherein the quartz crystal microbalance assembly comprises a housing, a support member, and the crystal, wherein the support member has a first portion and a second portion, wherein the second portion extends at least partially along an abutment surface of the housing, wherein an edge of the dry-facing crystal surface of the crystal is bonded to an abutment surface of the first portion of the support member, wherein the second portion of the support member is connected to an abutment surface of the housing, wherein an outer surface of the housing extends into the hole of the wall of the laboratory-scale equipment, wherein a side of the crystal i) faces an inside surface of the support member and ii) is not bonded to the inside surface of the support member.

Aspect 19. A process for mounting a crystal of a quartz crystal microbalance assembly to a wall of a laboratory-scale equipment, comprising: placing the crystal into a hole formed in the wall of the laboratory-scale equipment such that a liquid-facing crystal surface of the crystal is flush with an inner surface of the wall of the laboratory-scale equipment, wherein the hole comprises a first portion and a second portion that are configured to form an abutment surface; and connecting an edge of a dry-facing crystal surface of the crystal to the abutment surface, wherein a side of the crystal i) faces a side wall of the first portion of the hole and ii) is not bonded to the side wall of the first portion of the hole.

Aspect 20. A process for mounting a crystal of a quartz crystal microbalance assembly to a wall of a laboratory-scale equipment, comprising: placing the crystal into a hole in the wall of the laboratory-scale equipment such that a liquid-facing crystal surface of the crystal is flush with an inner surface of the wall of the laboratory-scale equipment, wherein the quartz crystal microbalance assembly comprises a support member having a first portion extending into the hole and a second portion extending on an outer surface of the wall of the laboratory-scale equipment, wherein an edge of a dry-facing crystal surface of the crystal is bonded to an abutment surface of the first portion of the support member; and connecting the second portion of the support member to the outer surface of the wall, wherein a side of the crystal i) faces a side wall of the hole and ii) is not bonded to the side wall of the hole.

Aspect 21. A process for mounting a crystal of a quartz crystal microbalance assembly to a wall of a laboratory-scale equipment, comprising: placing the quartz crystal microbalance assembly into a hole in the wall of the laboratory-scale equipment such that a liquid-facing crystal surface of the crystal is flush with an inner surface of the wall of the laboratory-scale equipment, wherein the quartz crystal microbalance assembly comprises a housing, a support member, and the crystal, wherein the support member has a first portion and a second portion, wherein the second portion extends along an abutment surface of the housing, wherein an edge of a dry-facing crystal surface of the crystal is bonded to an abutment surface of the first portion of the support member, wherein the second portion of the support member is connected to the inner surface of the housing; and connecting the housing to the wall of the laboratory-scale equipment, wherein a side of the crystal i) faces an inside surface of the support member and ii) is not bonded to the inside surface of the support member.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A process for measuring a particle deposition value in a laboratory-scale equipment, the process comprising:
flowing a liquid in or through the laboratory-scale equipment;
during flowing, contacting the liquid with a liquid-facing crystal surface of a crystal of a quartz crystal microbalance assembly;
detecting a resonant frequency of the crystal of the quartz crystal microbalance assembly based on the contacting; and
converting the resonant frequency to the particle deposition value,
wherein the liquid-facing crystal surface of the crystal is flush with an inner surface of a wall of the laboratory-scale equipment,
wherein the liquid-facing crystal surface is free-floating for shear oscillation of the liquid-facing crystal surface in a first plane relative to a dry-facing crystal surface of the crystal in a second plane, wherein the first plane is parallel to the second plane.

2. The process of claim 1, wherein the first plane of the liquid-facing crystal surface of the crystal is parallel to a direction of flow of the liquid.

3. The process of claim 1, wherein the liquid-facing crystal surface of the crystal is exposed to a shear in a range of from 0.01 to 1,000 Pa during contacting the liquid with the liquid-facing crystal surface of the crystal.

4. The process of claim 3, wherein the liquid-facing crystal surface of the crystal is exposed to a shear in a range of from 0.1 to 100 Pa during contacting the liquid with the liquid-facing crystal surface of the crystal.

5. The process of claim 1, wherein the quartz crystal microbalance assembly extends through a hole in the wall of the laboratory-scale equipment.

6. The process of claim 5, wherein the hole comprises a first portion and a second portion configured to form an abutment surface, wherein an edge of the dry-facing crystal surface of the crystal is bonded to the abutment surface.

7. The process of claim 6, wherein a side of the crystal faces a side wall of the first portion of the hole.

8. The process of claim 6, wherein a side of the crystal is not bonded to a side wall of the first portion of the hole.

9. The process of claim 5, wherein the quartz crystal microbalance assembly comprises a support member having a first portion extending into the hole and a second portion extending on an outer surface of the wall of the laboratory-scale equipment, wherein the second portion of the support member is connected to the outer surface of the wall, wherein an edge of the dry-facing crystal surface of the crystal is bonded to an abutment surface of the first portion of the support member.

10. The process of claim 9, wherein a side of the crystal faces a side wall of the hole.

11. The process of claim 9, wherein a side of the crystal is not bonded to a side wall of the hole.

12. The process of claim 5, wherein the quartz crystal microbalance assembly comprises a housing, a support member, and the crystal, wherein the support member has a first portion and a second portion, wherein the second portion extends at least partially along an abutment surface of the housing, wherein an edge of the dry-facing crystal surface of the crystal is bonded to an abutment surface of the first portion of the support member, wherein the second portion of the support member is connected to an abutment surface of the housing.

13. The process of claim 12, wherein a side of the crystal faces an inside surface of the support member.

14. The process of claim 12, wherein a side of the crystal is not bonded to an inside surface of the support member.

15. A laboratory-scale equipment configured to measure particle deposition of a liquid, comprising:
a wall comprising a hole formed therein; and
a quartz crystal microbalance assembly comprising a crystal, wherein the crystal extends into the hole of the wall, wherein a liquid-facing crystal surface of the crystal is flush with an inner surface of the wall of the laboratory-scale equipment, wherein the liquid-facing crystal surface is free-floating for shear oscillation of the liquid-facing crystal surface in a first plane relative to a dry-facing crystal surface of the crystal in a second plane, wherein the first plane is parallel to the second plane.

16. The laboratory-scale equipment of claim 15, wherein the hole comprises a first portion and a second portion configured to form an abutment surface, wherein an edge of the dry-facing crystal surface of the crystal is connected to the abutment surface, wherein a side of the crystal i) faces a side wall of the first portion of the hole and ii) is not bonded to the side wall of the first portion of the hole.

17. The laboratory-scale equipment of claim 15, wherein the quartz crystal microbalance assembly comprises a support member having a first portion extending into the hole and a second portion extending on an outer surface of the wall of the laboratory-scale equipment, wherein an edge of the dry-facing crystal surface of the crystal is bonded to an abutment surface of the first portion of the support member, wherein the second portion of the support member is connected to the wall via the outer surface of the wall, wherein a side of the crystal i) faces a side wall of the hole and ii) is not bonded to the side wall of the hole.

18. The laboratory-scale equipment of claim 15, wherein the quartz crystal microbalance assembly comprises a housing, a support member, and the crystal, wherein the support member has a first portion and a second portion, wherein the second portion extends at least partially along an abutment surface of the housing, wherein an edge of the dry-facing crystal surface of the crystal is bonded to an abutment surface of the first portion of the support member, wherein the second portion of the support member is connected to an abutment surface of the housing, wherein an outer surface of the housing extends into the hole of the wall of the laboratory-scale equipment, wherein a side of the crystal i) faces an inside surface of the support member and ii) is not bonded to the inside surface of the support member.

19. A process for mounting a crystal of a quartz crystal microbalance assembly to a wall of a laboratory-scale equipment,
a) wherein the process comprises:
placing the crystal into a hole formed in the wall of the laboratory-scale equipment such that a liquid-facing crystal surface of the crystal is flush with an inner surface of the wall of the laboratory-scale equipment, wherein the hole comprises a first portion and a second portion that are configured to form an abutment surface; and
connecting an edge of a dry-facing crystal surface of the crystal to the abutment surface,
wherein a side of the crystal i) faces a side wall of the first portion of the hole and ii) is not bonded to the side wall of the first portion of the hole;
or
b) wherein the process comprises:
placing the crystal into a hole in the wall of the laboratory-scale equipment such that a liquid-facing crystal surface of the crystal is flush with an inner surface of the wall of the laboratory-scale equipment, wherein the quartz crystal microbalance assembly comprises a support member having a first portion extending into the hole and a second portion extending on an outer surface of the wall of the laboratory-scale equipment, wherein an edge of a dry-facing crystal surface of the crystal is bonded to an abutment surface of the first portion of the support member; and
connecting the second portion of the support member to the outer surface of the wall,
wherein a side of the crystal i) faces a side wall of the hole and ii) is not bonded to the side wall of the hole;
or
c) wherein the process comprises:
placing the quartz crystal microbalance assembly into a hole in the wall of the laboratory-scale equipment such that a liquid-facing crystal surface of the crystal is flush with an inner surface of the wall of the laboratory-scale equipment, wherein the quartz crystal microbalance assembly comprises a housing, a support member, and the crystal, wherein the support member has a first portion and a second portion, wherein the second portion extends along an abutment surface of the housing, wherein an edge of a dry-facing crystal surface of the crystal is bonded to an abutment surface of the first portion of the support member, wherein the second portion of the support member is connected to the inner surface of the housing; and
connecting the housing to the wall of the laboratory-scale equipment,
wherein a side of the crystal i) faces an inside surface of the support member and ii) is not bonded to the inside surface of the support member.
